(19) United States
(12) Patent Application Publication
(10) Pub. No.: US 2022/0284347 A1
(43) Pub. Date: Sep. 8, 2022

(54) Method and device for processing data associated with a plurality of physical devices

(71) Applicant: Robert Bosch GmbH, Stuttgart (DE)

(72) Inventor: Paulius Duplys, Markgroeningen (DE)

(21) Appl. No.: 17/681,119

(22) Filed: Feb. 25, 2022

(30) Foreign Application Priority Data
Mar. 2, 2021 (DE) 10 2021 201 976.5

(51) Int. Cl. G06N 20/00; G06K 9/62

(52) U.S. Cl. CPC G06N 20/00; G06K 9/6284; G06K 9/6256

(57) ABSTRACT

A method such as a computer-implemented method for processing data associated with a plurality of physical devices. The method comprises: providing at least one digital representation for the physical devices, characterizing the behavior of the digital representation based on a machine learning method.

### FIELD

The present invention relates to a method for processing data associated with a plurality of physical devices.

In addition, the present invention relates to a device for processing data associated with a plurality of physical devices.

### SUMMARY

Exemplary embodiments of the present invention relate to a method, e.g., a computer-implemented method, for processing data associated with a plurality of physical devices, the method including: providing at least one digital representation for the physical devices in each case; characterizing the behavior of the digital representation based on a machine learning method.

In further exemplary embodiments, this makes it possible to efficiently obtain information about an operation of the physical devices or the respective digital representation.

In further exemplary embodiments of the present invention, at least one physical device of the plurality of physical devices may be or include a technical product, for instance an electrical and/or electronic device, e.g., an embedded system or a control unit, for instance for a vehicle such as a motor vehicle, and/or for a cyber-physical system or robot or production system.

In further exemplary embodiments of the present invention, the physical devices are of the same or a similar type.

In additional exemplary embodiments of the present invention, a digital representation such as precisely one digital representation may be allocated to at least one physical device of the plurality of physical devices.

In further exemplary embodiments of the present invention, the digital representation may be embodied as a digital twin or have a digital twin, for example.

In other exemplary embodiments of the present invention, the digital representation or the digital twin may be characterized by at least one data structure, e.g., a persistent data structure, (storable or stored in a non-volatile manner, for instance). In additional exemplary embodiments, the data structure, for instance, may characterize or represent a last known state (e.g., an operating state, the contents of a memory (e.g., a digital memory), sensor values, physical parameters (e.g., the position, etc.) of a physical device.

In further exemplary embodiments of the present invention, the method includes: grouping the physical devices and/or their digital representations based on a state characterized by the respective digital representation, for example according to at least one operating condition of the respective physical device, at least one group, for example, being obtained in the process.

In additional exemplary embodiments of the present invention, the method includes: evaluating the behavior of the digital representation of at least one group of the physical devices and/or their digital representations or of the at least one group of the physical devices and/or their digital representations.

In further exemplary embodiments of the present invention, the method includes: ascertaining at least one outlier in relation to the at least one group and, optionally, identifying the at least one outlier as an anomaly.

In other exemplary embodiments of the present invention, the method includes: transmitting data associated with the at least one outlier and/or data characterizing the at least one outlier, for instance to another unit such as a device designed to carry out security tasks in the field of information theory such as a security operations center.

In additional exemplary embodiments of the present invention, the machine learning method is a method of the unsupervised learning type.

Additional exemplary embodiments of the present invention relate to a device for executing a method according to the embodiments.

Additional exemplary embodiments of the present invention relate to a computer-readable memory medium which includes instructions that when carried out by a computer, induce the computer to carry out the method according to the embodiments.

Additional exemplary embodiments of the present invention relate to a computer program which includes instructions that when the program is carried out by a computer, induce the computer to carry out the method according to the embodiments.

Further exemplary embodiments of the present invention relate to a data carrier signal which transmits and/or characterizes the computer program according to the embodiments.

Additional exemplary embodiments of the present invention relate to a use of the method according to the embodiments, and/or of the device according to the embodiments, and/or of the computer-readable memory medium according to the embodiments, and/or of the computer program according to the embodiments, and/or of the data carrier signal according to the embodiments for at least one of the following elements: a) characterizing the behavior of the digital representation; b) characterizing the behavior of at least one physical device; c) providing a system for detecting attacks, e.g., an intrusion detection system; d) using a machine learning method such as of an unsupervised learning type, e.g., for evaluating and/or analyzing a behavior or an operation of a digital twin of a physical device; e) ascertaining or detecting a deviating behavior, e.g., an operating behavior, of a digital twin and/or of a physical device such as a behavior, e.g., operating behavior, that deviates from an average behavior of a group.

Additional features, application possibilities and advantages of the present invention result from the following description of exemplary embodiments of the present invention shown in the figures. All described or illustrated features, on their own or in any combination, constitute the subject matter of the present invention, regardless of their wording or representation in the description and/or the figures.

### BRIEF DESCRIPTION OF THE DRAWINGS

FIG. 1 shows schematically a simplified flow diagram according to exemplary embodiments of the present invention.

FIG. 2 shows schematically a simplified flow diagram according to exemplary embodiments of the present invention.

FIG. 3 shows schematically a simplified block diagram according to exemplary embodiments of the present invention.

FIG. 4 shows schematically a simplified block diagram according to exemplary embodiments of the present invention.

FIG. 5 shows schematically aspects of uses according to exemplary embodiments of the present invention.

### DETAILED DESCRIPTION OF EXAMPLE EMBODIMENTS

Exemplary embodiments, shown in FIG. 1, relate to a method, e.g., a computer-implemented method, for processing data associated with a plurality of physical devices PE-1, PE-2, . . . , PE-n, the method including: supplying 100 at least one digital representation DT-1, DT-2, . . . , DT-n for the physical devices PE-1, PE-2, . . . , PE-n; and characterizing 102 the behavior VH-1, VH-2, . . . , VH-n of the digital representation(s) DT-1, DT-2, . . . , DT-n based on a machine learning method ML. In further exemplary embodiments, this makes it possible to efficiently obtain information about an operation of the physical devices PE-1, PE-2, . . . , PE-n or the respective digital representation DT-1, DT-2, . . . , DT-n.

In further exemplary embodiments, at least one physical device PE-1 of the plurality of physical devices PE-1, PE-2, . . . , PE-n may be or include a technical product, for instance an electrical and/or electronic device such as an embedded system or a control unit, e.g., for a vehicle such as a motor vehicle, and/or for a cyber-physical system or robot or production system.

In further exemplary embodiments, a digital representation DT-1, e.g., precisely one digital representation DT-1, may be allocated to at least one physical device PE-1 of the plurality of physical devices PE-1, PE-2, . . . , PE-n.

In further exemplary embodiments, the digital representation DT-1 may be embodied as a digital twin or have a digital twin, for instance.

In additional exemplary embodiments, the digital representation DT-1 or the digital twin may be characterized by at least one, e.g., persistent, data structure (for instance storable or stored in a non-volatile manner). In further exemplary embodiments, the data structure is able to characterize or represent a last known state (e.g., an operating state, a content of a memory (e.g., a digital memory), sensor values, physical parameters (e.g., a position) and others of a physical device PE-1, for example.

In additional exemplary embodiments, the method includes: grouping 104 the physical devices PE-1, PE-2, . . . , PE-n and/or their digital representations DT-1, DT-2, . . . , DT-n based on a state characterized by the respective digital representation DT-1, DT-2, . . . , DT-n, e.g., according to at least one operating condition of the respective physical device, at least one group G-1 being obtained in the process, for example.

In further exemplary embodiments, the grouping 104 may supply a plurality of groups and, for example, elements of the respective group have or experience at least similar operating conditions, e.g., operating conditions that lie within a predefinable frame.

In additional exemplary embodiments, the method includes: evaluating 106 the behavior of the digital representation of at least one group G-1 of the physical devices and/or their digital representations or of the at least one group G-1 of physical devices and/or its digital representations.

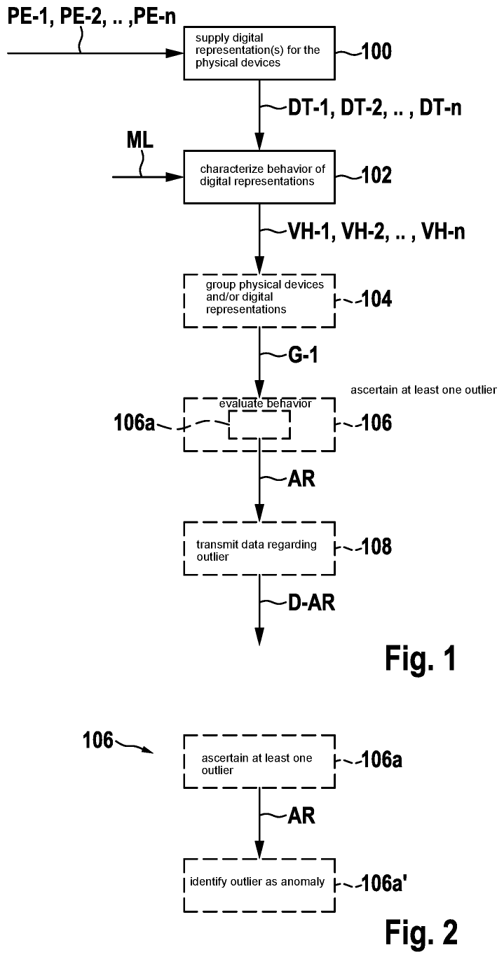

In other exemplary embodiments, FIG. 2, the method includes: ascertaining 106a at least one outlier AR in relation to the at least one group G-1, and, optionally, identifying 106a′ the at least one outlier AR as an anomaly.

In further exemplary embodiments, FIG. 1, the method includes: transmitting 108 data D-AR associated with the at least one outlier AR and/or data D-AR characterizing the at least one outlier AR, for instance to a further unit such as a device configured to carry out safety tasks in the field of information theory, e.g., a security operations center, SOC (FIG. 4).

In additional exemplary embodiments, the machine learning method ML (FIG. 1) is a method of an unsupervised learning type, for instance.

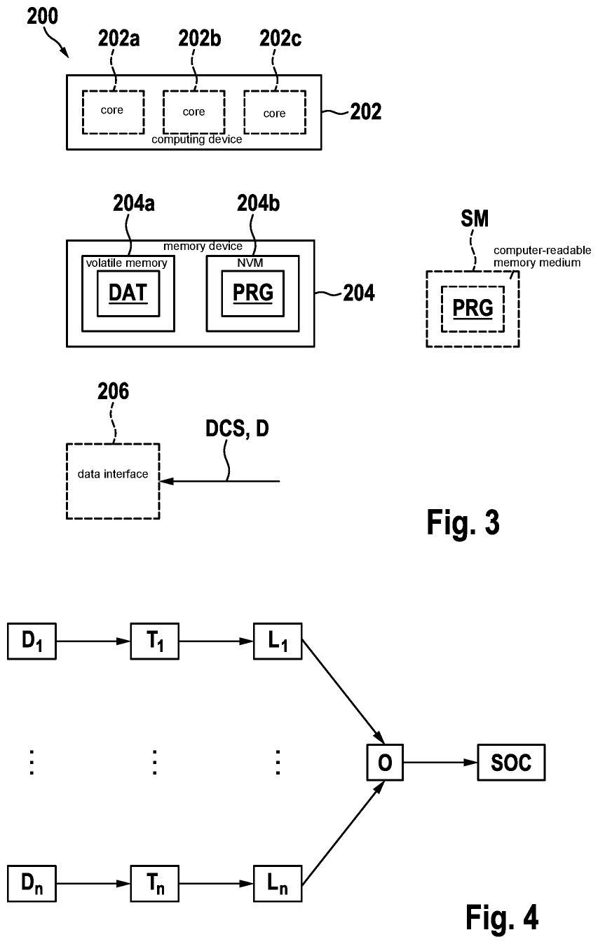

Additional exemplary embodiments, FIG. 3, relate to a device 200 for carrying out the method according to the embodiments. Device 200 has at least one computing device (computer) 202 having (three, in this instance) processor core(s) 202a, 202b, 202c, a memory device 204 allocated to computing device 202 for the at least temporary storing of at least one of the following elements: a) data DAT, b) computer program PRG, in particular for carrying out a method according to the embodiments.

In other exemplary embodiments, memory device 204 has a volatile memory 204a (e.g., a working memory (RAM)) and/or a non-volatile (NVM) memory 204b (e.g., Flash EEPROM).

In other exemplary embodiments, computing device 202 has at least one of the following elements or is embodied as at least one of these elements: a microprocessor (μP), a microcontroller (μC), an application-specific integrated circuit (ASIC), a system on a chip (SoC), a programmable logic component (e.g., an FPGA, field programmable gate array), a hardware circuit or any combinations thereof.

Additional exemplary embodiments relate to a computer-readable memory medium SM, which includes instructions PRG which when executed by a computer 202, induce the computer to carry out the method according to the embodiments.

Further exemplary embodiments relate to a computer program PRG, which includes instructions that when the program is executed by a computer 202, induce the computer to carry out the method according to the embodiments.

Other exemplary embodiments relate to a data carrier signal DCS, which characterizes and/or transmits the computer program PRG according to the embodiments. Data carrier signal DCS may be received via an optional data interface 206 of device 200, for example. In further exemplary embodiments, data D associated with the plurality of physical devices PE-1, PE-2, . . . , PE-n and/or data D-AR associated with the at least one outlier AR (FIG. 1) and/or data D-AR characterizing the at least one outlier AR, for example, are also transmittable via optional data interface 206.

In the following text, further exemplary aspects and advantages according to additional exemplary embodiments are described which, individually or in combination with one another, are able to be combined with at least one of the afore-described embodiments.

In further exemplary embodiments, FIG. 4, digital representations or twins T₁, . . . , Tₙ are provided for multiple physical devices D₁, . . . , Dₙ (e.g., n>10 or n>100 or n>1000 or more), e.g., multiple physical devices of the same or a similar type (e.g., control units for a component of a motor vehicle).

In further exemplary embodiments, at least one machine learning method, e.g., unsupervised learning, is used, e.g., during an operation of the multiple physical devices D₁, . . . , Dₙ, see blocks L₁, . . . , Lₙ according to FIG. 4, for instance in order to characterize the behavior such as the operating behavior of the digital representations or twins T₁, . . . , Tₙ—and thus, for example, also the behavior such as the operating behavior of the multiple physical devices D₁, . . . , Dₙ.

In further exemplary embodiments, the multiple physical devices D₁, . . . , Dₙ or their digital representations or twins T₁, . . . , Tₙ are grouped, for example based on their operating conditions, e.g., on the respective state as characterizable by the corresponding digital representation, for example. One or more group(s) may be obtained in the process in further exemplary embodiments.

In additional exemplary embodiments, the group(s) is/are monitored or analyzed, e.g., including an evaluation of the output variable(s) of the machine learning methods L₁, . . . , Lₙ, e.g., in order to ascertain and/or identify outliers, compare block O according to FIG. 4.

In other exemplary embodiments, outliers are viewed or identified as outliers, for instance in the sense of an intrusion detection method, and information associated with the anomalies (e.g., the identity and/or state, and/or (the degree of) the deviation of the operating behavior in relation to the associated group, for example) is optionally able to be transmitted to a further unit such as a security operations center SOC.

In additional exemplary embodiments, outliers are able to be examined in further detail, e.g., in an automated manner and/or by a human security analyst, for example.

In other exemplary embodiments, the following aspects are utilized and/or taken into account: if it is assumed, for example, that not all physical devices D₁, . . . , Dₙ are able to be attacked or manipulated simultaneously, which can be ensured by providing a few reference devices, e.g., in a secure environment, then manipulated or attacked physical devices in further exemplary embodiments will at least intermittently exhibit or have a behavior that deviates from the physical devices that were not attacked (e.g., characterizable by a time sequence of states).

In further exemplary embodiments, machine learning methods, e.g., of the unsupervised learning type, are suitable for acquiring characteristic features of the (deviating) behavior, for example. For that reason, in further exemplary embodiments, characteristic features of attacked and non-attacked physical devices are able to be distinguished, which allows for observing or monitoring in further exemplary embodiments, for instance in order to identify outliers (possibly both in attacked and non-attacked devices), which may be utilized for a more detailed analysis in additional exemplary embodiments, for instance performed by a human specialized.

In additional exemplary embodiments, machine learning methods of the unsupervised learning type are able to be used to find patterns in data or data records not known or observed previously, for instance without a predefined classification or labels and, for instance, with relatively minor or no human intervention. In other exemplary embodiments, machine learning methods of the unsupervised learning type are able to be used to model probability densities based on inputs.

In other exemplary embodiments, the use of unsupervised learning methods makes it possible to dispense with the requirement or use of rules or lists (e.g., whitelist, blacklist, etc.). Instead, unsupervised learning methods in further exemplary embodiments are capable of ‘autonomously’ learning the characteristics of the behavior of the physical devices or their digital representations.

In other exemplary embodiments, unsupervised learning methods (which can be carried out in parallel with the operation of the physical devices, for example) make it possible to consider also a changing, e.g., “benign”, behavior of the physical devices (e.g., in case of a software update), and/or to learn the changed behavior.

In further exemplary embodiments, the understanding may be utilized in a multitude of physical devices, for example, that when a relatively small number of k physical devices (or their digital twins) exhibits a deviating behavior (e.g., under similar operating conditions as all further physical devices), it may be inferred that anomalies relating to the number k of physical devices have occurred that should possibly be examined in greater detail, for instance if all physical devices have the same software (version) and/or firmware (version), and/or if all physical devices operate under similar conditions (such as a similar amount of incoming network traffic and others, for example).

In further exemplary embodiments, the behavior or operating behavior able to be conveyed to the machine learning methods L₁, . . . , Lₙ, e.g., as input data, may include different information such as: a) a quantity of outgoing network traffic (e.g., output data rate if important and/or applicable). e.g., to network addresses such as IP addresses outside an own network, and/or b) a number and/or ID of open network ports (e.g., TCP ports, UDP, http, and others), and/or c) an (average, for example) processor load of a CPU, and/or d) a number of processes such as processes of an operating system, and/or e) a memory requirement (e.g., working memory).

In additional exemplary embodiments, a digital twin Tₖ may be a (data) object, for example, which stores key value pairs, which describe one or more properties of the corresponding physical device Dₖ, for instance.

In further exemplary embodiments, a state of digital twin Tₖ is able to be transmitted as input data to a corresponding machine learning module Lₖ (e.g., of the unsupervised learning type).

In other exemplary embodiments, learning module Lₖ may be designed to perform a cluster analysis which, for instance, groups input data, e.g., not labeled and/or classified and/or categorized input data, for example. In additional exemplary embodiments, the cluster analysis may identify commonalities of the input data and cluster, i.e., group, the data based on the existence or non-existence of those commonalities, for instance.

In further exemplary embodiments, an input buffer is able to be provided for learning module Lₖ. Output data of learning modules L₁ bis Lₖ in other exemplary embodiments are able to be conveyed to block O (FIG. 4), which may perform comparisons and/or an outlier detection, for instance. Block O, for example, compares the characteristics learned with the aid of learning modules L₁ through Lₖ such as a number and type of groups in case of a cluster analysis. If at least one outlier is present (e.g., ascertainable by the comparison), that is so say, if one or more digital twin(s) exhibit(s) a behavior that deviates from the other digital twins (or the corresponding physical devices), for instance, then block O in further exemplary embodiments is able to transmit an alarm to block SOC, for example, which in further exemplary embodiments is able to be checked, e.g., by a human analyst.

In other exemplary embodiments, modules L₁ through Lₖ may also perform other (e.g., statistical) evaluations in relation to the data conveyed with the aid of the digital twins or, in general terms, carry out one or more other mappings of the individual input data, for instance to the characteristics, which are conveyable to block O, for example.

In additional exemplary embodiments, employing the principle according to the embodiments, a differential anomaly detection is able to be carried out, which is based, for instance, on a comparison of characteristics of a plurality of physical devices or their digital representations instead of describing an expected and/or unexpected behavior of the devices, for instance.

For example, the principle according to the embodiments does not require any rules or sets of rules, e.g., in the sense of blacklists and/or whitelists, which are used in conventional approaches and have to be defined in advance, as the case may be. In other words, in the exemplary embodiments based on the principle according to the embodiments, for instance, it is not necessary to understand how an individual physical device should actually behave when it functions properly, e.g., is not manipulated and/or when it is manipulated. Instead, anomalies in further exemplary embodiments are able to be identified by comparisons, such as described earlier in the text. For that reason, an effective attack detection such as an intrusion detection is able to be carried out in exemplary embodiments, for instance for physical devices whose expected behavior is completely unknown.

In other exemplary embodiments, the principle according to the embodiments may be used to carry out and/or offer services for monitoring and/or an intrusion detection and/or anticipatory servicing, e.g., predictive maintenance, e.g., without customers of this service having to divulge details of a function of the physical device to be monitored, for example.

In additional exemplary embodiments, the differential approach allows for a simple adaptation to or consideration of an operating behavior of the physical devices that varies over time, for instance as a result of a software update.

In additional exemplary embodiments, all physical devices having the same version of software or firmware have an identical or similar behavior, for example, which means there is no need to understand a function or the effects of software updates. In additional exemplary embodiments, it is not even necessary to know which changes a certain software update causes in the operating behavior of the physical devices. In further exemplary embodiments, this makes it possible to offer an intrusion detection (attack detection), for instance, as a continuous service even in target systems for which a user of the service does not divulge any internal details about the physical devices to be monitored (e.g., communications devices for a bus system) and/or about a software change.

In other exemplary embodiments, a plane able to be characterized by the aspects of machine learning method ML may be used to adjust a sensitivity such as for an attack detection.

In some embodiments, for example, the outlier detection can be too sensitive, for instance if block O (FIG. 4) were to make direct use of the (state) values of the digital representations because every difference in the (state) values could detect an anomaly and trigger a security alarm, for example.

In additional exemplary embodiments, the level able to be characterized by the aspects of machine learning method ML is therefore used for ascertaining more robust features which describe the behavior of the physical devices, for example based on the (state) values of the digital representations.

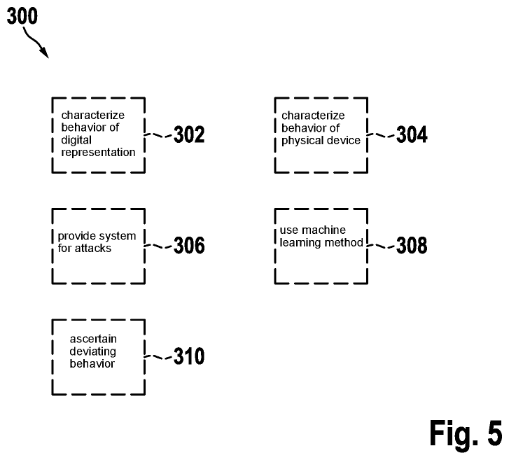

Additional exemplary embodiments, FIG. 5, relate to a use 300 of the method according to the embodiments, and/or of the device according to the embodiments, and/or of the computer-readable memory medium according to the embodiments, and/or of the computer program according to the embodiments, and/or of the data carrier signal according to the embodiments for at least one of the following elements: a) characterizing 302 the behavior of the digital representation; b) characterizing 304 the behavior of at least one physical device; c) providing 306 a system, e.g., a differential system, for detecting attacks such as an intrusion detection system; d) using 308 a machine learning method ML, e.g., of the unsupervised learning type, such as for evaluating and/or analyzing a behavior or an operation of a digital twin of a physical device; e) ascertaining 310 or detecting a deviating behavior, e.g., operating behavior, of a digital twin and/or a physical device, for instance, such as a behavior, e.g., an operating behavior, that deviates from an average behavior of a group.

1.-11. (canceled)

12. A computer-implemented method for processing data associated with a plurality of physical devices, the method comprising:
providing at least one digital representation for each of the physical devices; and
characterizing a behavior of each of the digital representations based on a machine learning method.

13. The method as recited in claim 12, further comprising:
grouping the physical devices and/or the digital representations, based on a state characterized by the respective digital representations according to at least one operating condition of the respective physical devices, at least one group being obtained.

14. The method as recited in claim 13, further comprising:
evaluating a behavior of a digital representation of the at least one group of the physical devices and/or the digital representations.

15. The method as recited in claim 14, further comprising:
ascertaining at least one outlier in relation to the at least one group;

16. The method as recited in claim 15, further comprising:
identifying the at least one outlier as an anomaly.

17. The method as recited in claim 15, further comprising:
transmitting data associated with the at least one outlier and/or data characterizing the at least one outlier, to another unit, the other unit including a device which is configured to carry out security tasks in the field of information theory.

18. The method as recited in claim 17, wherein the device is a security operations center.

19. The method as recited in claim 12, wherein the machine learning method is a method of an unsupervised learning type.

20. A device for processing data associated with a plurality of physical devices, the method comprising:
providing at least one digital representation for each of the physical devices; and
characterizing a behavior of each of the digital representations based on a machine learning method.

21. A non-transitory computer-readable memory medium on which are stored instructions for processing data associated with a plurality of physical devices, the instructions, when executed by a computer, causing the computer to perform:
providing at least one digital representation for each of the physical devices; and
characterizing a behavior of each of the digital representations based on a machine learning method.

22. The method as recited in claim 12, wherein the method is used for at least one of the following elements: a) characterizing the behavior of the digital representations, b) characterizing the behavior of at least one of the physical devices, c) detecting attacks including an intrusion detection system, d) using the machine learning method of the unsupervised learning type for evaluating and/or analyzing a behavior or an operation of a digital twin of a physical device, e) ascertaining or detecting a deviating operating behavior of a digital twin and/or a physical device including an operating behavior deviating from an average behavior of a group.
